(19) United States
(12) Patent Application Publication
(10) Pub. No.: US 2006/0075607 A1
(43) Pub. Date: Apr. 13, 2006

(54) Metrogrip

(76) Inventor: Christine Goulden, (US)

Correspondence Address: LAW OFFICES OF J.D. GERAIGERY, P.C., 56 CREIGHTON STREET, CAMBRIDGE, MA, 02140, US

(21) Appl. No.: 10/963,056

(22) Filed: Oct. 12, 2004

(51) Int. Cl. H01M 2/10

(52) U.S. Cl. 16/444

(57) ABSTRACT

A portable hand-held grip for commuters of public transportation having a nylon strap (30) with a loop-handle (20) at each end and a piece of flexible non-slip material (10) sewn in the center between the two loop-handles.

### CROSS REFERENCE TO RELATED APPLICATIONS

Not Applicable

### FEDERALLY SPONSORED RESEARCH

Not Applicable

### SEQUENCE LISTING, TABLE, OR COMPUTER PROGRAM

Not applicable

### BACKGROUND OF THE INVENTION—FIELD OF INVENTION

This invention relates to portable hand grips, specifically to such hand grips which are used by standing persons for maintaining balance, where such hand grips are also comfortable and hygienic.

### BACKGROUND OF THE INVENTION

Standing commuters are meant to grip vertical and horizontal poles, which are built into train cars and buses, in order to steady themselves while traveling if unable to claim a seat. Typically, during peak commuting hours, especially in metropolitan cities, mass transportation becomes overly crowded and congested.

People tend to stand near to the exits for a number of reasons:

(a) Trains and buses are often so congested that it is difficult for people to enter and exit, hence commuters wish to stand closer to the doorway in order for a quicker exit.

(b) In many trains, standing in the center of the car would require holding on to an overhead horizontal pole, which can be both uncomfortable and unsanitary. The congestion on mass transportation poses a number of problems. For one, the spreading of germs is more rampant, as commuters stand in tight clusters and also, the number of hands that touch the same metal poles is practically immeasurable, and thus ideal for the spreading of germs. In order to avoid touching the poles, very often commuters will lean against train doors. This is a dangerous practice, as train doors could malfunction and result in injury to commuters. Also, standing against the doors allows commuters freedom of both hands with which to read, eat, drink, and hold bags, briefcases, and other items. If a commuter were to hold on to a pole, he/she would be left with only one free hand, which is inconvenient, especially on longer rides. Further, for most people, holding onto overhead horizontal poles proves to be uncomfortable, especially if held onto for prolonged periods of time. Additionally, an alternative method used by commuters for avoidance of holding onto to horizontal poles barehanded, is to use a tissue product or to use one's sleeve as a barrier between the pole and hand. The disadvantage of this practice is the added litter left behind by used tissues, as well as stretching the commuter's clothing.

### BACKGROUND OF THE INVENTION—OBJECTS AND ADVANTAGES

There are a number of advantages of the present invention, which are:

(a) to provide a hand grip which is compact and portable;

(b) to provide a hand grip which is washable and less conducive to the accumulation and spreading of germs;

(c) to provide a hand grip which is comfortable to the touch, as well as more ergonomical;

(d) to provide a hand grip which will encourage commuters to stand towards the center of train cars and buses, thus promoting rider safety and lending aid to the upkeep of schedules, as doorways will be less crowded, hence allowing for quicker entering and exiting train cars and buses.

### SUMMARY

In accordance with the present invention a portable hand grip comprises a durable strap with loop handles sewn at both ends, along with a non-slip material adhered to the center of the strap for friction against horizontal poles.

### DRAWINGS—FIGURES

FIG. 1 shows both front and side views of the present invention.

FIG. 2 shows the present invention as it would sit on a horizontal pole.

### DRAWINGS—REFERENCE NUMERALS

10 non-slip material

20 hand grip

30 strap material

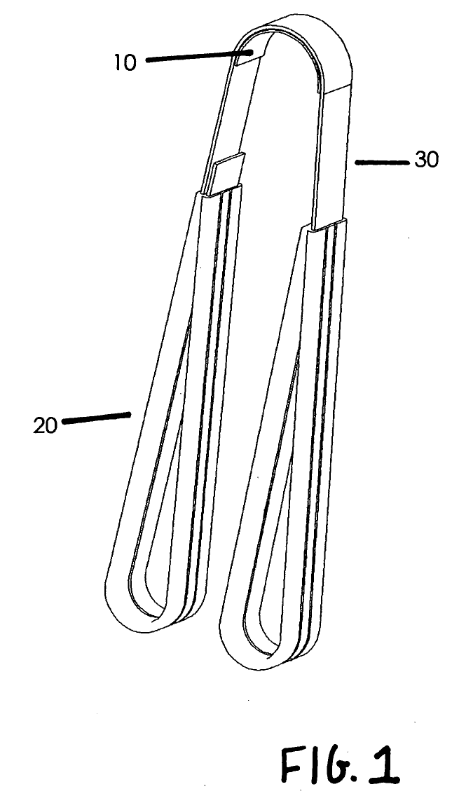

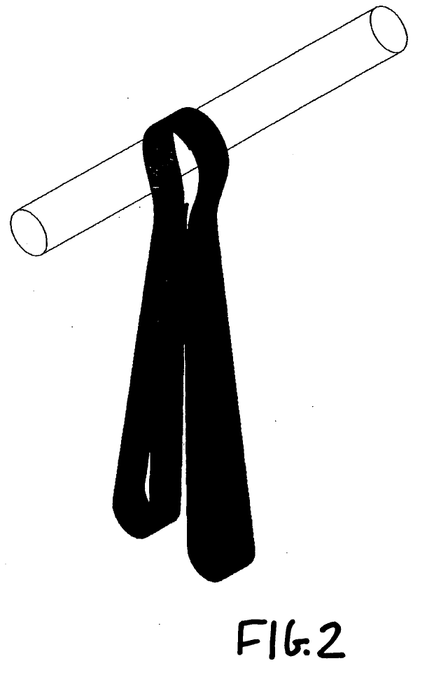

### DESCRIPTION—FIGS. 1 AND 2-PREFERRED EMBODIMENT

A preferred embodiment of the present invention is illustrated in FIG. 1. The strap 30 has the approximate dimensions of 0.75 inches in width and 34.5 inches in length. In the preferred embodiment, the strap 30 is made of high-strength nylon with 1200 lbs break strength commercial grade Mil-W-17337. However, the strap can consist of any other material which has a minimum break strength of 500 lbs, is flexible, and washable.

The hand grip material 20 is wrapped around each end of the strap 30 and is sewn in a loop shape to form hand holds. In the preferred embodiment, the hand grip material 20 is made from man-made leather micro polymer fiber in the approximate dimensions of 1.5 inches in width and 13.5 inches in length per handle. The hand grip material is sewn with double stitching for increased strength. However, the hand grips can consist of any other material which is flexible, breathable, and washable.

A piece of non-slip material 10 is sewn at the approximate midpoint between the two hand holds, with the approximate dimensions of 0.75 inches in width and 3 inches in length. In the preferred embodiment, the non-slip material is comprised of polyester knit coated with non-slip abrasion resistant copolymer, and is sewn on both top and underside of the nylon strap to provide interchangeable usage of both sides of the present invention. However, the non-slip piece can consist of any material which is abrasion resistant, washable, and flexible without cracking.

Also, the present invention as a whole can be constructed in any number of possible lengths, widths, and colors as suitable to various heights of commuters, height and widths of horizontal poles, and consumer preferences.

Operation—FIG. 2

The manner of using the Metro Grip invention is to gently flip one hand grip over the horizontal pole, while securely holding the second hand grip, where the non-slip material 10 rests on the pole. Next, the loose hand grip is brought together with the second hand grip to where both hand grips are adjacent and form a single hand grip. This is the final position of the invention in usage to provide secure gripping of the horizontal pole.

Advantages

A number of advantages are evident:
(a) The Metro Grip is a more hygienic alternative to barehanded holding of horizontal poles on public transportation.
(b) The Metro Grip is flexible and foldable, thus compact for easy storage and carrying.
(c) The Metro Grip is washable, thus hygienic and economical.
(d) The Metro Grip allows for more comfortable riding on mass transit for the user and surrounding passengers by encouraging commuters to move away from the overcrowded vertical poles and in front of subway doors.
   Conclusion, Ramifications, and Scope

Accordingly, the reader will see that the Metro Grip can be used to provide a more hygienic, comfortable, and safer method of stabling one's balance while commuting on public transportation. The advantages listed above should not be construed as limiting the scope of the invention but as merely providing illustrations of some of the presently preferred embodiments of the invention. For example, the Metro Grip may be made from different materials, in different sizes, and in different colors.

Thus the scope of the invention should be determined by the appended claims and their legal equivalents, rather than by the examples given.

I claim:

1. A portable device for standing humans to stabilize balance while commuting on public transportation, comprising:
(a) a strap of material sufficient in strength to support the weight of a standing human
(b) a loop hole at both ends to be used as hand grips
(c) a piece of abrasive non-slip material centered on the strap equidistant to both hand grips.
